(19) United States
(12) Patent Application Publication
(10) Pub. No.: US 2013/0304599 A1
(43) Pub. Date: Nov. 14, 2013

(54) METHOD AND SYSTEM OF CONDUCTING INTERACTIVE ONLINE AUCTIONS

(71) Applicant: INTERACTIVE BID GAMES, INC., Ranch Palos Verdes, CA (US)

(72) Inventor: Martin Vincent, Malibu, CA (US)

(73) Assignee: INTERACTIVE BID GAMES, INC., Rancho Palos Verdes, CA (US)

(21) Appl. No.: 13/803,240

(22) Filed: Mar. 14, 2013

Related U.S. Application Data
(60) Provisional application No. 61/645,907, filed on May 11, 2012.
(60) Provisional application No. 61/646,036, filed on May 11, 2012.
(60) Provisional application No. 61/646,061, filed on May 11, 2012.
(60) Provisional application No. 61/646,087, filed on May 11, 2012.

(51) Int. Cl. G06Q 30/08

(52) U.S. Cl. CPC G06Q 30/08
USPC 705/26.3

(57) ABSTRACT

A method and system of conducting interactive online auctions are disclosed. The method includes presenting via a network-connected auction system for viewing by users information on items for sale; presenting a first auction interface for a first item; receiving from a first group of users a plurality of pre-cap purchases, wherein each pre-cap purchase entitles user to place at least one bid for the first item; presenting an interactive chat room that enables users in the first group to communicate with each other, wherein access to the interactive chat room is limited to the first auction interface; when the received pre-cap purchases reach a threshold level, implementing a bidding interface having a bid submission interface and a timer; starting the timer; receiving from the first group of users a plurality of bids, wherein the bids correspond to the pre-cap purchases; and awarding first item to user who places the final bid before the timer ends.

### CROSS REFERENCE TO RELATED APPLICATIONS

This application claims the benefit of U.S. Provisional Application Nos. 61/645,907, 61/646,036, 61/646,061, and 61/646,087, filed May 11, 2012, which are incorporated by reference in their entireties.

### TECHNICAL FIELD

The present invention relates to the field of online penny auctions.

### BACKGROUND

Conventional online penny auctions and reverse penny auctions are types of entertainment auctions in which participant bidders qualify to play by purchasing a bundle of bids that vary in price depending on the website. Penny auctions are configured to operate such that the price of the offered item increases by a penny each time a participant bids for such item. During the online penny auction, a backward counting timer restarts each time a new bid is placed. When the counter reaches zero, the last bidder wins an opportunity to purchase the auctioned item at the resulting price, which is often times at 10-25% of the retail price.

Winning participants of online penny auctions often receive a significant discount off the manufacturer's suggested retail price of an auctioned item. When bidding is closed, other participants who are not successful in winning the auctioned item are left with nothing but the costs incurred for their participation in the online auction.

Today's online penny auction environment is suspect in the prolific use of programmed “bots” (i.e., fake players) to outbid real players, such that the online auctioneer never has to fulfill the won auctioned item. Moreover, conventional online penny auctions encourage emotional or otherwise uncontrollable bidding in that unsuccessful participants incur all costs for participating in the auction even if they do not win the auctioned item. In addition, conventional online penny auctions do not allow users to communicate with each other because users could realize the internal behavior of such penny auctions as most penny auctions have bots bidding that would become evident if a chat interface or other user communication was implemented within such conventional penny auction websites. Further, the current online penny auction environment lacks sufficient entertainment value to participants to actively engage participants to participate in such online penny auctions for the latest in demand items on the market for a fraction of the retail price.

### SUMMARY

In a first aspect, there is provided herein a method of conducting an interactive online auction. The method includes: presenting, via a network-connected auction system for viewing by a plurality of users, information regarding a plurality of items that are for sale via the interactive online auction; presenting, via the auction system, a first auction interface for a first one of the items; receiving, from a first group of the users via the first auction interface, a plurality of pre-capitalization purchases, wherein each pre-capitalization purchase entitles the purchasing user to place at least one bid for the first item; presenting, via the auction system through the auction interface, an interactive chat room that enables the users in the first group to communicate with each other, wherein access to the interactive chat room is limited to the first auction interface and is not available via any other auction interface for any other of the items; when the received pre-capitalization purchases reach a threshold level, implementing, via the first auction interface, a bidding interface, wherein the bidding interface comprises a bid submission interface and a timer; starting the timer; receiving, from the first group of users a plurality of bids, wherein the bids correspond to the pre-capitalization purchases; and awarding the first item to the user who places the final bid before the timer reaches an end point.

In certain embodiments, the method further includes periodically pausing the timer and concurrently stopping the bidding interface to enable the users in the first group to chat via the interactive chat room.

In certain embodiments, the method further includes displaying, via the interactive chat room, identifying information for each user who posts a communication to the first interactive chat room.

In certain embodiments, the method further includes: receiving, via the bidding interface, a plurality of bids; determining a sum of the received bids; and when the sum reaches each of a plurality of thresholds, automatically pausing the timer and disabling the bidding interface from receiving bids for a time period to enable the users in the first group to chat via the interactive chat room.

In certain embodiments, wherein presenting, via the auction system, the first auction interface includes: transmitting, by a web server of the auction system, information for display of the auction interface by a plurality of remote user computing devices; and transmitting, by a messaging server of the auction system, information for display of the interactive chat room by the plurality of remote user computing devices.

In certain embodiments, wherein before presenting the first auction interface, receiving, from a sponsor, a request to sponsor an auction for the first item; in response to the request, generating a token that, when used, will provide access to the first auction interface; and sending the token to the sponsor for distribution to a plurality of potential auction participants via an invitation.

In certain embodiments, the method further includes after awarding the first item to the user who places the final bid, causing a portion of the received pre-capitalization purchases to be shared with the sponsor.

In certain embodiments, wherein presenting the interactive chat room includes, for each user, presenting the interactive chat room only after the user has submitted a bid for the first item.

In certain embodiments, wherein presenting the interactive chat room includes: presenting a first field to accept user messages; presenting a second field to display messages received from users in the first group; and presenting a third field for presenting messages of auction status and system events.

In certain embodiments, wherein presenting messages of auction status and system events includes generating a plurality of defined events for triggering of a plurality of messages from an online script auctioneer.

In certain embodiments, wherein implementing the bidding interface includes: sending an alert to users in the first group, wherein the alert comprises an auction start time; when the auction start time is reached, accepting bids and starting the timer; receiving a first bid from a first one of the users; causing the first auction interface to display the first bid and an identification of the first user; disabling the first user's ability to submit an additional bid until the system receives a second bid from a different one of the users; and re-enabling the first user's ability to submit an additional bid after the system receives the second bid.

In certain embodiments, the method further includes implementing a bid purchase interface such that the bidding interface includes a function that enables a user to use credits from a social network to purchase the pre-capitalization purchases.

In certain embodiments, the method further includes implementing, via the first auction interface, a pre-capitalization interface, wherein each time the user commits bids or tokens to participate in the interactive online auction, a total amount of committed bids or tokens is determined by the auction system and a resulting amount is compared with a previously configured pre-capitalization amount, such that if the resulting amount is equal or higher than the pre-capitalization amount, a start auction event is triggered so that the auction system may inform the users via a plurality of remote user computing devices.

In certain embodiments, the method further includes executing, via the auction system, a software script configured to manage and control the interactive online auction time frame, wherein the software script is configured to pause each time the received pre-capitalization purchases reach a threshold level or other qualifying events are met such that the timer is re-set to a shorter time frame.

In certain embodiments, the interactive online auction is a penny auction.

In a further aspect, there is provided herein a system of conducting an interactive online auction. The system includes a computer-readable storage medium containing programming instructions that, when implemented, instruct the processor to implement an interactive online auction by: presenting, via a network-connected auction system for viewing by a plurality of users, information regarding a plurality of items that are for sale via the interactive online auction; presenting, via the auction system, a first auction interface for a first one of the items; receiving, from a first group of the users via the first auction interface, a plurality of pre-capitalization purchases, wherein each pre-capitalization purchase entitles the purchasing user to place at least one bid for the first item; presenting, via the auction system through the auction interface, an interactive chat room that enables the users in the first group to communicate with each other, wherein access to the interactive chat room is limited to the first auction interface and is not available via any other auction interface for any other of the items; when the received pre-capitalization purchases reach a threshold level, implementing, via the first auction interface, a bidding interface, wherein the bidding interface comprises a bid submission interface and a timer; starting the timer; receiving, from the first group of users a plurality of bids, wherein the bids correspond to the pre-capitalization purchases; and awarding the first item to the user who places the final bid before the timer reaches an end point.

In certain embodiments, the timer is configured to be periodically paused and the bidding interface is configured to be concurrently stopped to enable the users in the first group to chat via the interactive chat room.

In certain embodiments, identifying information is configured to be displayed, via the interactive chat room, for each user who posts a communication to the first interactive chat room.

In certain embodiments, the system further includes: a plurality of bids configured to be received via the bidding interface; a sum of the received bids configured to be determined; wherein the timer is configured to be automatically paused and the bidding interface is configured to be disabled from receiving bids for a time period to enable the users in the first group to chat via the interactive chat room when the sum reaches each of a plurality of thresholds.

In certain embodiments, a web server of the auction system is configured to transmit information for display of the first auction interface by a plurality of remote user computing devices, and a messaging server of the auction system is configured to transmit information for display of the interactive chat room by the plurality of remote user computing devices.

In certain embodiments, the system further includes: a request configured to be received from a sponsor to sponsor an auction for the first item before the first auction interface is presented via the auction system; a token configured to be generated in response to the request such that the token will provide access to the first auction interface; wherein the token is configured to be sent to the sponsor for distribution to a plurality of potential auction participants via an invitation.

In certain embodiments, a portion of received pre-capitalization purchases is configured to be shared with the sponsor after the first item is awarded to the user who places the final bid.

In certain embodiments, the interactive chat room is configured to be available for each user once the user has submitted a bid for the first item.

In certain embodiments, the interactive chat room includes: a first field to accept user messages; a second field to display messages received from users in the first group; and a third field for presenting messages of auction status and system events.

In certain embodiments, a plurality of defined events is configured to trigger a plurality of messages from an online script auctioneer.

In certain embodiments, the bidding interface includes an alert configured to be sent to users in the first group, wherein the alert comprises an auction start time; a plurality of bids configured to be accepted and the timer configured to be started when the auction start time is reached; a first bid configured to be received from a first one of the users; the first auction interface configured to display the first bid and an identification of the first user; the first user's ability to submit an additional bid is configured to be disabled until the system receives a second bid from a different one of the users; wherein the first user's ability to submit an additional bid is configured to be re-enabled after the system receives the second bid.

In certain embodiments, the system further includes a bid purchase interface such that the bidding interface is configured with a function that enables a user to use credits from a social network to purchase the pre-capitalization purchases.

In certain embodiments, a pre-capitalization interface is configured to operate such that each time the user commits bids or tokens to participate in the interactive online auction, a total amount of committed bids or tokens is determined by the auction system and a resulting amount is compared with a previously configured pre-capitalization amount, such that if the resulting amount is equal or higher than the pre-capitalization amount, a start auction event is triggered so that the auction system may inform a plurality of remote user computing devices.

In certain embodiments, a software script is configured to manage and control the interactive online auction time frame, wherein the software script is configured to pause each time the received pre-capitalization purchases reach a threshold level or other qualifying events are met such that the timer is re-set to a shorter time frame.

In certain embodiments, the interactive online auction is a penny auction.

Various advantages of this disclosure will become apparent to those skilled in the art from the following detailed description, when read in light of the accompanying drawings.

### BRIEF DESCRIPTION OF THE DRAWINGS

FIG. 1 illustrates various elements of an online auction system.

FIG. 2 illustrates an example of various components of an auction interface.

FIG. 3 is a flowchart illustrating various steps that a method of conducting an interactive online auction may implement.

FIG. 4 illustrates an example of various components of a chat interface.

FIG. 5 illustrates a block diagram of hardware that may be used to contain or implement program instructions according to an embodiment.

### DETAILED DESCRIPTION

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimensions recited below. Nothing in this document is to be construed as an admission that the embodiments described in this document are not entitled to antedate such disclosure by virtue of prior invention. As used herein, the term “comprising” means “including, but not limited to.”

The following terms shall have, for purposes of this application, the respective meanings set forth below:

A “computing device” refers to a device that includes a processor and tangible, computer-readable memory. The memory may contain programming instructions that, when executed by the processor, cause the computing device to perform one or more operations according to the programming instructions. Examples of computing devices include personal computers, servers, mainframes, gaming systems, televisions, and portable electronic devices such as smartphones, personal digital assistants, cameras, tablet computers, laptop computers, media players and the like.

The terms “bidder”, “participant”, “player”, and “user” are used interchangeably throughout this disclosure and shall have the same meanings of each other if one term is used in place of another. Such terms refer to a party who qualifies to participate in the interactive online auction disclosed herein.

In consideration of the figures, it is to be understood for purposes of clarity certain details of construction and/or operation are not provided in view of such details being conventional and well within the skill of the art upon disclosure of the document described herein.

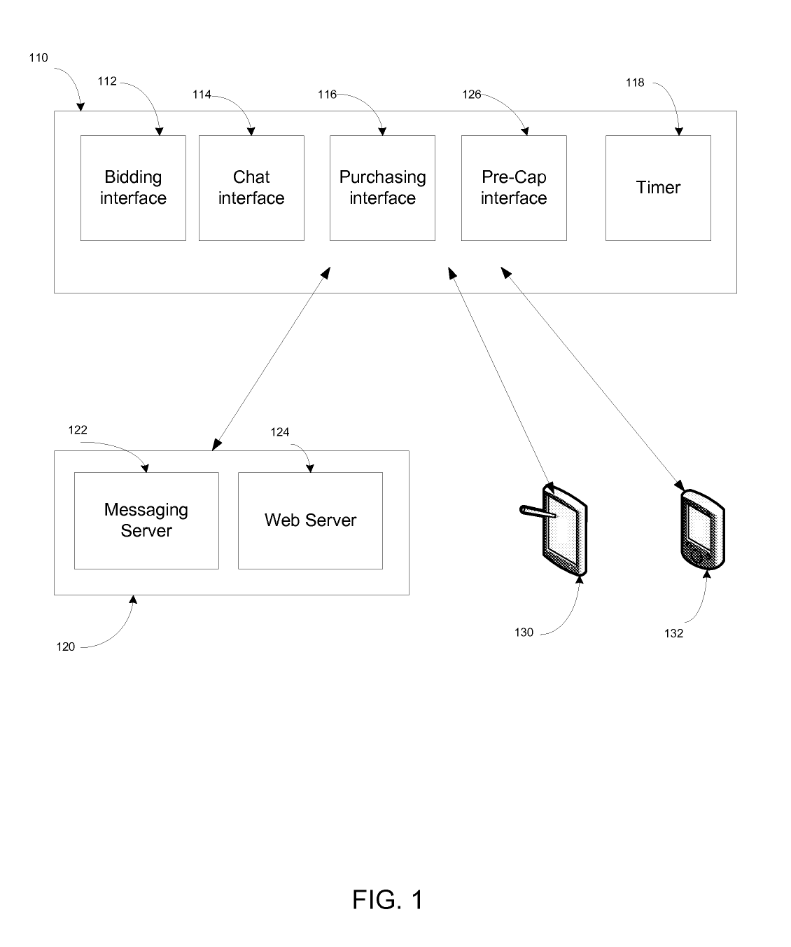

Referring now to FIG. 1 is a block diagram illustrating an example of a system for conducting an interactive online auction. The system includes an auction system 120 that serves various interfaces to one or more user electronic devices 130, 132 via a communications network such as the Internet or a wireless data communications network. The system 120 may include one or more servers that provide the functions of a messaging server 122 and a web server 124. The messaging server 122 informs a web browser or other software application of the number of auctions available at a moment in time and provides the information necessary to display the auction details to the users. The web server 124 generates and sends information to various users that enable the users to receive and/or transmit information on their electronic devices 130, 132. The term “web server” may include traditional web servers that provide data for viewing on browsers, application servers that receive data from and transmit data to one or more software applications on portable electronic devices, or other mechanisms now or hereafter known for creating and serving interfaces and data to multiple users via a communications network.

The auction system 120 presents each user electronic device with an auction interface 110 that implements an auction for one or more items to be auctioned. The auction interface may include a bidding interface 112 in which users may submit bids, and a chat interface 114 that provides an interactive chat room in which participants in an auction for an item may communicate with each other in a group discussion forum. The auction interface also may include a purchasing interface 116 wherein users may purchase pre-capitalization purchases, i.e., tokens or bids that may be used to place bids when an auction begins. The auction interface also may include a pre-capitalization interface 126 wherein each time the user commits bids or tokens to participate in the interactive online auction, a total amount of committed bids or tokens is determined by the auction system 120 and a resulting amount is compared with a previously configured pre-capitalization amount, such that if the resulting amount is equal or higher than the pre-capitalization amount, a start auction event is triggered so that the auction system may inform the users via a plurality of remote user computing devices 130, 132. The auction interface also may include a timer 118 such as a clock or a graphic illustration that represents the time remaining until an auction starts, or the time remaining in an auction after the auction begins.

The pre-capitalization interface 126 may exist in either a social network (e.g., Facebook) platform or a website or other software application format in which the interface is integrated (e.g., via Facebook Connect) so that the interface may be shared among users in the online auction.

The interactive online auction of the present disclosure includes two types of currency, namely, tokens and bids, which may be used by the player to participate in the online auction. The first type of currency, tokens, enable users to play for select virtual items and additional tokens via the interactive online auction system for free and once the users accumulate a predetermined amount (e.g., 50,000 tokens), users may exchange the tokens for a predetermined amount of bids (e.g., 5 bids) in order to play for real or otherwise non-virtual items. Users of the interactive online auction system may acquire a predetermined amount of tokens (e.g., 2,000 tokens) the first time they open the application of the interactive online auction via either a social network (e.g., Facebook) or a website or other application without relying on any social network. Each time the user invites a friend to the interactive online auction, the user may obtain a predetermined amount of tokens (e.g., 500 tokens) to compete in the online auction. The second type of currency, bids, enable users to play for real or otherwise non-virtual items in the interactive online auction. Thus, to acquire bids to participate in the interactive online auction, the user must either purchase them or exchange tokens for bids via the purchasing interface 116 of the auction system 120.

It is to be understood that the method and system for conducting interactive online auctions of the present disclosure are contemplated to be used with penny auctions, reverse penny auctions, and the like, but are not necessarily limited to such types of online auctions and may be used in conjunction with other types of online auctions as appropriate either via a social network (e.g., Facebook, Google+, Yahoo, etc.) or website or other application format.

Before the interactive online auction begins, each potential user determines how many bids the he or she would like to commit in trying to win a particular item. The price of all items (regardless of the actual retail price) at the start of the online auction is zero dollars. Each user has the option to retract his or her bid commitment at any time before the auction begins. In addition, each potential user must satisfy a series of qualification steps in order to be eligible to participate in the interactive online auction as implemented in a social network and/or as generically implemented without relying on any social network (e.g., website). In an exemplary embodiment, the following steps apply to the qualification of a user to participate in the interactive online auction via a social network: (1) the user may install or open the application, such as in the social network and/or in a mobile version and confirms his or her user name information and e-mail and/or other identifying information, optionally, as provided by the social network's platform, as well as a contacts or friends list for inviting other participants to the online auction; (2) the user must have sufficient tokens or bids to commit or otherwise put at risk during the auction with respect to the user's pre-capitalization purchases; (3) the user must wait until the auction begins or for a start notification, such as an electronic mail notification via the social network; (4) after the user commits his or her pre-capitalization purchases, the user is allowed access to the first interactive chat room, which is unique to the auction interface for the first item and will not be presented via the auction interfaces for other items; however, the user will not be allowed to participate in the chat room until a pre-capitalization purchase is made; (5) once the pre-capitalization amount is met for the online auction, no new users will be allowed into the auction; and (6) a software script auctioneer will start a countdown and the interactive online auction will begin among the qualified participants after the pre-capitalization purchases reach a threshold amount, such as at least two to three times the actual retail value of the item to be auctioned or another predetermined amount.

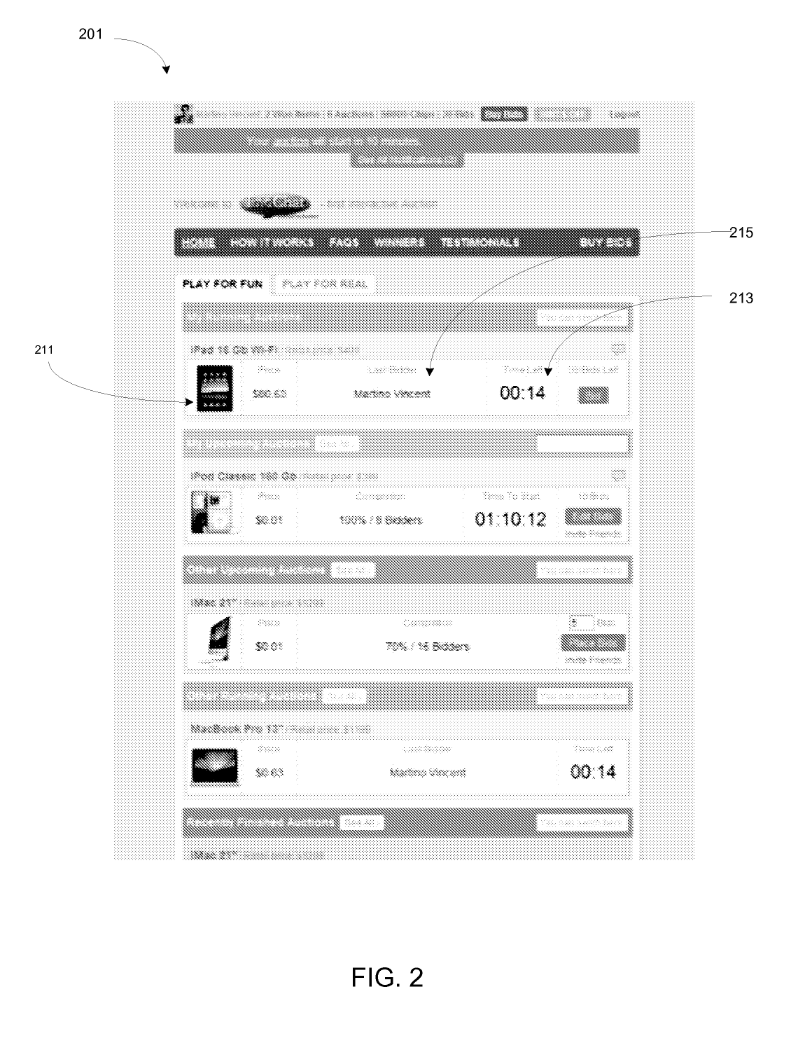

FIG. 2 illustrates an example of a display of an electronic device that presents a page of an auction interface 201. In this case, the auction interface outputs information representing the item that is being auctioned 211, an identification of the latest bidder in the auction 215, and a timer 213 illustrating the time remaining in the auction. In this way, the system as illustrated operates as what is commonly known as a “penny auction,” where users purchase the right to place bids, each of which has an equal value. The users then place bids, typically one at a time, until time runs out. When the timer indicates that time has run out, the last bidder wins the auction and receives the item.

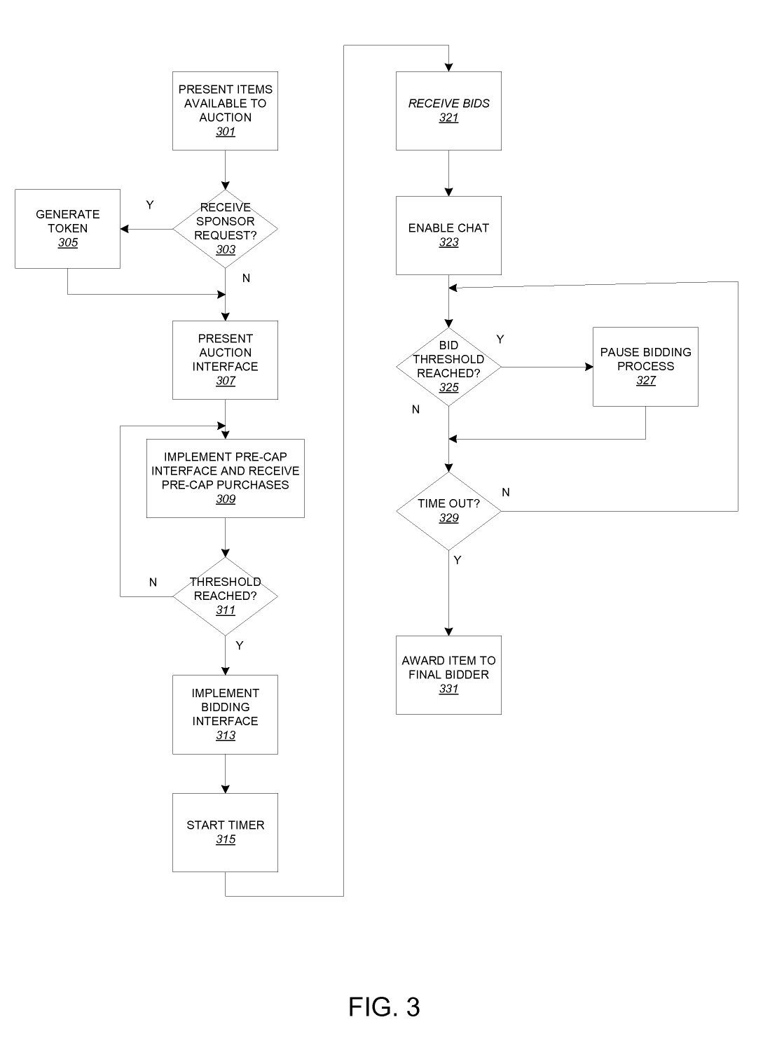

FIG. 3 is a flowchart illustrating an example of how an auction system may implement an interactive online auction. The system may present information regarding multiple auction items to users 301, optionally via an auction interface 307 or other presentation method. For each item, users will have the opportunity to purchase bids or exchange tokens for bids, referred to in this document as pre-capitalization purchases. This interface may be done via a purchasing interface of the auction system. Each pre-capitalization purchase will entitle the user to place one or more bids for that item by “capitalizing” the online auction. The capitalization of an online auction occurs when users intending to bid on a certain item commit a total number of their pre-purchased bid rights that will be used to try to win the item. Optionally, the purchases may be made with cash, a credit account, or a debit account. Optionally, the purchases may be made with credits from another online system, such as a social network.

After the pre-capitalization purchases are received and the pre-capitalization interface is implemented 309 and such purchases reach a predetermined threshold 311, the system may authorize the auction to start and implement a bidding interface 313. Optionally, the bidding interface 313 may alert the users who made the pre-capitalization purchases of a start time for the auction. Alternatively, the auction may start immediately.

If the system delays the start, it may send an alert to users in the first group. The alert may include a start time for the auction. When the auction start time is reached, the system may accept bids and start the timer.

Upon the start, the system will start a timer 315 that counts down (or up) to an end time. While the timer is counting, the users who made pre-capitalization purchases (i.e., committed bids) may spend those purchases to place bids, and the system will receive the bids 321 until the system reaches the end of the time for the auction 329. The system may display an identifier for each person as they submit bids. When the timer starts to count down (or up), this represents the time the auction for that item has reached a pre-established minimum of participants for that particular item. Each time a user submits a bid on a particular item, the timer re-sets to its original predetermined time and the price of the item for auction goes up by a penny. Optionally, when a user submits a bid, the system may disable that user from submitting bids until another user submits a bid. After the other user submits a bid, the first user's bidding capability may be re-enabled. At the end of the time, the system will award the item to the bidder who submitted the final bid before time ran out 331.

The system will also include a chat interface 323 that enables the pre-capitalization purchasers to communicate with each other via text, video, and/or audio. The chat room will display identifying information (such as a username and/or image) for each user who posts a communication to the first interactive chat room. At least some of the communications will be visible to all potential bidders. However, the chat interface will be unique to the auction for that item, so that bidders may chat with each other without interference by chat among bidders for other items. Thus, the chat room that the chat interface provides will be unique to the auction interface for the first item and will not be presented via the auction interfaces for other items. Optionally, in addition to system administrators (such as a virtual or live auctioneer), only bidders who made pre-capitalization purchases and/or who submit bids may participate in the chat room. The chat interface may include fields such as a first field to accept user messages, a second field to display messages received from users in the first group, and a third field for presenting messages from an auctioneer of the online system.

In some embodiments, at various points during the bidding process, the system may pause the bidding process 327 to give users time to communicate via the chat interface. For example, the system may automatically sum the bids received, and automatically pause the bidding when the total bids received reach one or more thresholds, such as 25% of a required bid amount, 50% of the required bid amount, and/or 75% of the required bid amount.

Optionally, before starting the auction, the system may enable one or more sponsors to sponsor an auction (i.e., charity, educational, non-profit, private, etc.). If the system receives a sponsor request 303, it may generate a token that identifies the auction 305. The token may be, for example, a hyperlink to the auction interface, a security code or access code, or another token that directs and/or enables users to participate in the auction. The sponsor may promote the auction by sending the token to multiple users via an invitation message. In exchange, at the end of the auction the system may reward the sponsor by causing a portion of the received pre-capitalization purchases to be shared with the sponsor. In an example, the sponsor or promoter of the auction may receive 10% of the value of the item (or another predetermined amount) to be auctioned in a positive electronic payment via PayPal after a user wins the item.

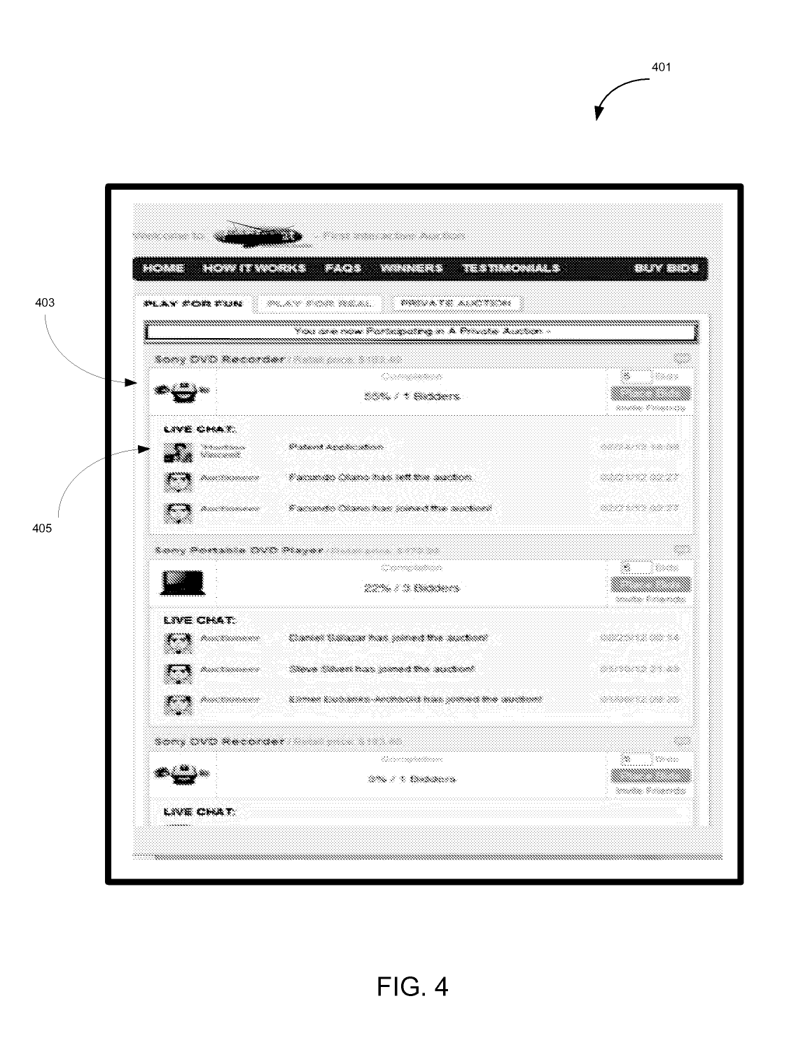

FIG. 4 illustrates an example of a display of an electronic device that presents a page of a chat interface 401 in a private online auction. The chat interface 401 provides an interactive chat room in which the users in an auction for an item may communicate with each other in a group discussion forum. In this case, the chat interface outputs information representing the item that is being auctioned 403 and an identification of each participant (including the online script auctioneer) in the live chat 405 for each separate auction. The chat interface 401 captures the user information and displays each participant in the live chat with information from each participant's user profile. When the online auction is conducted within a social network platform, the chat interface 401 will capture information from the user's social network profile to be displayed for identification of each participant. The display will record all user transmissions in reverse chronological order with the most recent transmission at top, including a time and date stamp of the transmission.

In use, the chat interface 401 appears automatically when the user starts participating in an online auction, typically when the user places bids or tokens in the auction. The chat interface 401 is configured to include a text field for introducing users' respective chat messages, a button to submit what is entered into the text field to the server and then to the other users, an area reserved for the online script auctioneer messages, and an area where all the remaining messages (i.e., user generated and system generated) are shown. Chat message data stored in the server depends on the particular auction. When the server sends the chat message through a message broadcasting system, the server only addresses the message to the specific users participating in the online auction.

In some embodiments, the online script auctioneer is triggered upon the occurrence of a plurality of defined events in which a message is sent on behalf of the online script auctioneer to all users participating in the interactive online auction. In particular, the online script auctioneer starts the online auction and facilitates the timer to reset to a lower time after a user has placed a bid for a first item. The online script auctioneer may be triggered when the pre-capitalization purchases have been achieved for the online auction or other qualifying events have been met, such as when the status of the auction changes from “pre-cap” to “started” or “started” to “end”, when time passes, and upon every action taken by users that changes the state of the auction in the software's execution time of the interactive online auction system.

In accordance with the method and system of the disclosure, a software script of the interactive online auction system may be configured to manage and control the online auction time frame and pause the online script auctioneer each time the respective percentages of the pre-cap bids are achieved (FIG. 3) or other qualifying events are met, which causes the timer to be re-set to a shorter time frame. In an example, the timer starts at ten seconds and when the pre-cap bids are achieved to 50%, the online script auctioneer will pause and then re-set the time to five seconds. Subsequently, when the pre-cap bids are achieved to 75%, the online script auctioneer will pause and re-set the timer to three seconds to ensure that there will be a winner much quicker than other conventional online penny auctions that can potentially last for several days. The interactive online auction system of the present disclosure is contemplated to produce winners each hour in view of the configured pre-cap amount and the select number of participants, which enables users to win each hour as opposed to days like other conventional online penny auctions.

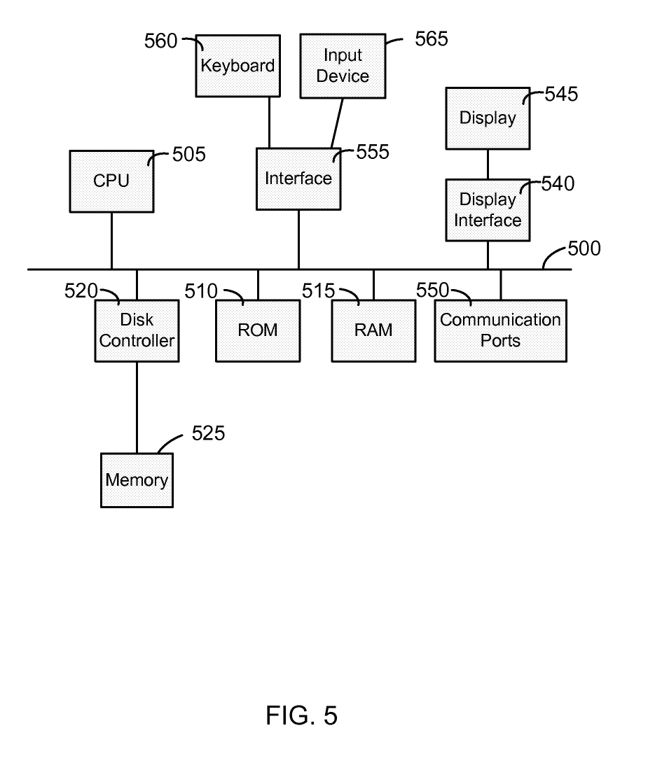

FIG. 5 depicts a block diagram of hardware that may be used to contain or implement program instructions. A bus 500 serves as an information highway interconnecting the other illustrated components of the hardware. CPU 505 is a central processing unit of the system, performing calculations and logic operations required to execute a program. CPU 505, alone or in conjunction with one or more of the other elements disclosed in FIG. 5, is an example of a production device, computing device or processor as such terms are used within this disclosure. Read only memory (ROM) 510 and random access memory (RAM) 515 constitute examples of non-transitory computer-readable storage media.

A controller 520 interfaces with one or more optional non-transitory computer-readable storage media 525 to the system bus 500. These storage media 525 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 510 and/or the RAM 515. Optionally, the program instructions may be stored on a tangible non-transitory computer-readable medium such as a compact disk, a digital disk, flash memory, a memory card, a USB drive, an optical disc storage medium, such as a Blu-ray™ disc, and/or other recording medium.

An optional display interface 530 may permit information from the bus 500 to be displayed on the display 535 in audio, visual, graphic or alphanumeric format. Communication with external devices, such as a printing device, may occur using various communication ports 540. A communication port 540 may be attached to a communications network, such as the Internet or an intranet.

The hardware may also include an interface 555 which allows for receipt of data from input devices such as a keyboard 550 or other input device 565 such as a mouse, a joystick, a touch screen, a remote control, a pointing device, a video input device and/or an audio input device.

Several of the features and functions disclosed above may be combined into different systems or applications, or combinations of systems and applications. Various presently unforeseen or unanticipated alternatives, modifications, variations or improvements therein may be subsequently made by those skilled in the art, each of which is also intended to be encompassed by the following claims.

What is claimed is:

1. A method of conducting an interactive online auction, comprising:
presenting, via a network-connected auction system for viewing by a plurality of users, information regarding a plurality of items that are for sale via the interactive online auction;
presenting, via the auction system, a first auction interface for a first one of the items;
receiving, from a first group of the users via the first auction interface, a plurality of pre-capitalization purchases, wherein each pre-capitalization purchase entitles the purchasing user to place at least one bid for the first item;
presenting, via the auction system through the auction interface, an interactive chat room that enables the users in the first group to communicate with each other, wherein access to the interactive chat room is limited to the first auction interface and is not available via any other auction interface for any other of the items;
when the received pre-capitalization purchases reach a threshold level, implementing, via the first auction interface, a bidding interface, wherein the bidding interface comprises a bid submission interface and a timer;
starting the timer;
receiving, from the first group of users a plurality of bids, wherein the bids correspond to the pre-capitalization purchases; and
awarding the first item to the user who places the final bid before the timer reaches an end point.

2. The method of claim 1, wherein the method further comprises periodically pausing the timer and concurrently stopping the bidding interface to enable the users in the first group to chat via the interactive chat room.

3. The method of claim 2, further comprising displaying, via the interactive chat room, identifying information for each user who posts a communication to the first interactive chat room.

4. The method of claim 1, wherein the method further comprises:
receiving, via the bidding interface, a plurality of bids;
determining a sum of the received bids; and
when the sum reaches each of a plurality of thresholds, automatically pausing the timer and disabling the bidding interface from receiving bids for a time period to enable the users in the first group to chat via the interactive chat room.

5. The method of claim 1, wherein presenting, via the auction system, the first auction interface comprises:
transmitting, by a web server of the auction system, information for display of the auction interface by a plurality of remote user computing devices; and
transmitting, by a messaging server of the auction system, information for display of the interactive chat room by the plurality of remote user computing devices.

6. The method of claim 1, further comprising:
before presenting the first auction interface:
receiving, from a sponsor, a request to sponsor an auction for the first item;
in response to the request, generating a token that, when used, will provide access to the first auction interface; and
sending the token to the sponsor for distribution to a plurality of potential auction participants via an invitation.

7. The method of claim 6, further comprising, after awarding the first item to the user who places the final bid, causing a portion of received pre-capitalization purchases to be shared with the sponsor.

8. The method of claim 1, wherein presenting the interactive chat room comprises, for each user, presenting the interactive chat room only after the user has submitted a bid for the first item.

9. The method of claim 1, wherein presenting the interactive chat room comprises:
presenting a first field to accept user messages;
presenting a second field to display messages received from users in the first group; and
presenting a third field for presenting messages of auction status and system events.

10. The method of claim 9, wherein presenting messages of auction status and system events comprises generating a plurality of defined events for triggering of a plurality of messages from an online script auctioneer.

11. The method of claim 1, wherein implementing the bidding interface comprises:
sending an alert to users in the first group, wherein the alert comprises an auction start time;
when the auction start time is reached, accepting bids and starting the timer;
receiving a first bid from a first one of the users;
causing the first auction interface to display the first bid and an identification of the first user;
disabling the first user's ability to submit an additional bid until the system receives a second bid from a different one of the users; and
re-enabling the first user's ability to submit an additional bid after the system receives the second bid.

12. The method of claim 1, further comprising:
implementing a bid purchase interface such that the bidding interface comprises a function that enables a user to use credits from a social network to purchase the pre-capitalization purchases.

13. The method of claim 1, further comprising:
implementing, via the first auction interface, a pre-capitalization interface, wherein each time the user commits bids or tokens to participate in the interactive online auction, a total amount of committed bids or tokens is determined by the auction system and a resulting amount is compared with a previously configured pre-capitalization amount, such that if the resulting amount is equal or higher than the pre-capitalization amount, a start auction event is triggered so that the auction system may inform the users via a plurality of remote user computing devices.

14. The method of claim 1, further comprising:
executing, via the auction system, a software script configured to manage and control the interactive online auction time frame, wherein the software script is configured to pause each time the received pre-capitalization purchases reach a threshold level or other qualifying events are met such that the timer is re-set to a shorter time frame.

15. The method of claim 1, wherein the interactive online auction is a penny auction.

16. A system for conducting an interactive online auction, comprising:
a processor;
a computer-readable storage medium containing programming instructions that, when implemented, instruct the processor to implement an interactive online auction by:
presenting, via a network-connected auction system for viewing by a plurality of users, information regarding a plurality of items that are for sale via the interactive online auction;
presenting, via the auction system, a first auction interface for a first one of the items;
receiving, from a first group of the users via the first auction interface, a plurality of pre-capitalization purchases, wherein each pre-capitalization purchase entitles the purchasing user to place at least one bid for the first item;
presenting, via the auction system through the auction interface, an interactive chat room that enables the users in the first group to communicate with each other, wherein access to the interactive chat room is limited to the first auction interface and is not available via any other auction interface for any other of the items;
when the received pre-capitalization purchases reach a threshold level, implementing, via the first auction interface, a bidding interface, wherein the bidding interface comprises a bid submission interface and a timer;
starting the timer;
receiving, from the first group of users a plurality of bids, wherein the bids correspond to the pre-capitalization purchases; and
awarding the first item to the user who places the final bid before the timer reaches an end point.

17. The system of claim 16, wherein the timer is configured to be periodically paused and the bidding interface is configured to be concurrently stopped to enable the users in the first group to chat via the interactive chat room.

18. The system of claim 16, wherein identifying information is configured to be displayed, via the interactive chat room, for each user who posts a communication to the first interactive chat room.

19. The system of claim 16 further comprising:
a plurality of bids configured to be received via the bidding interface;
a sum of the received bids configured to be determined;
wherein the timer is configured to be automatically paused and the bidding interface is configured to be disabled from receiving bids for a time period to enable the users in the first group to chat via the interactive chat room when the sum reaches each of a plurality of thresholds.

20. The system of claim 16, further comprising:
a web server of the auction system configured to transmit information for display of the first auction interface by a plurality of remote user computing devices; and
a messaging server of the auction system configured to transmit information for display of the interactive chat room by the plurality of remote user computing devices.

21. The system of claim 16, further comprising:
a request configured to be received from a sponsor to sponsor an auction for the first item before the first auction interface is presented via the auction system;
a token configured to be generated in response to the request such that the token will provide access to the first auction interface;
wherein the token is configured to be sent to the sponsor for distribution to a plurality of potential auction participants via an invitation.

22. The system of claim 21, wherein a portion of received pre-capitalization purchases is configured to be shared with the sponsor after the first item is awarded to the user who places the final bid.

23. The system of claim 16, wherein the interactive chat room is configured to be available for each user once the user has submitted a bid for the first item.

24. The system of claim 16, wherein the interactive chat room comprises:
a first field to accept user messages;
a second field to display messages received from users in the first group; and
a third field for presenting messages of auction status and system events.

25. The system of claim 24, wherein a plurality of defined events is configured to trigger a plurality of messages from an online script auctioneer.

26. The system of claim 16, wherein the bidding interface comprises:
an alert configured to be sent to users in the first group, wherein the alert comprises an auction start time;
a plurality of bids configured to be accepted and the timer configured to be started when the auction start time is reached;
a first bid configured to be received from a first one of the users;
the first auction interface configured to display the first bid and an identification of the first user;
the first user's ability to submit an additional bid is configured to be disabled until the system receives a second bid from a different one of the users;
wherein the first user's ability to submit an additional bid is configured to be re-enabled after the system receives the second bid.

27. The system of claim 16, further comprising:
a bid purchase interface such that the bidding interface is configured with a function that enables a user to use credits from a social network to purchase the pre-capitalization purchases.

28. The system of claim 16, further comprising:
a pre-capitalization interface configured to operate such that each time the user commits bids or tokens to participate in the interactive online auction, a total amount of committed bids or tokens is determined by the auction system and a resulting amount is compared with a previously configured pre-capitalization amount, such that if the resulting amount is equal or higher than the pre-capitalization amount, a start auction event is triggered so that the auction system may inform a plurality of remote user computing devices.

29. The system of claim 16, further comprising:
a software script configured to manage and control the interactive online auction time frame, wherein the software script is configured to pause each time the received pre-capitalization purchases reach a threshold level or other qualifying events are met such that the timer is re-set to a shorter time frame.

30. The system of claim 16, wherein the interactive online auction is a penny auction.
